(19) United States
(12) Patent Application Publication
(10) Pub. No.: US 2005/0034464 A1
(43) Pub. Date: Feb. 17, 2005

(54) Jet aircraft electrical energy production system

(76) Inventor: E. H. Gonzalez, Alice, TX (US)

Correspondence Address: LITMAN LAW OFFICES, LTD., P.O. BOX 15035 CRYSTAL CITY STATION, ARLINGTON, VA, 22215, US

(21) Appl. No.: 10/637,616

(22) Filed: Aug. 11, 2003

(51) Int. Cl. F02C 7/00

(52) U.S. Cl. 60/801

(57) ABSTRACT

The jet aircraft electrical energy production system produces electrical energy by ionizing airflow through a ram or gas turbine jet engine. The ionized particles in the airflow may also be separated, liquefied, stored for future utilization.

### BACKGROUND OF THE INVENTION

1. Field of the Invention

The present invention relates to aircraft power plants in general, and more particularly, to systems for producing electrical energy and liquefaction of air through fluid ionization.

2. Description of the Related Art

Improvement in the generation of electric energy is an ongoing goal of research scientists. Improving the capability of electricity production onboard an aircraft in flight is another area that has seen much research and development.

As disclosed in U.S. Pat. No. 6,486,483, issued to the present inventor, E. H. Gonzalez, on Nov. 26, 2002 and incorporated in its entirety in the current patent application, some of the most significant advances in the field of electric energy production have centered on thermal exciter units for forming plasma, which can then be used to generate electricity.

U.S. Pat. No. 3,119,233, issued to F. L. Wattendorf et al. in 1964, shows a multiple electrode arrangement for producing a diffused electrical discharge. The device includes a high velocity expansion nozzle, an assembly for providing high-pressure gas, a central electrode, a plurality of sharply pointed electrodes, a source of cooling gas, and a source for applying a high alternating voltage. Electrical energy may be generated either as a direct or alternating current output.

Supplying electric energy onboard an airplane in flight provides challenges unlike those encountered elsewhere. Weight concerns and fuel supply have limited the use of batteries and fuel driven electric generators. U.S. Pat. No. 5,899,411, issued to Latos et al. in 1999, discloses an aircraft electrical system having an air-driven generator to provide in-flight electrical starting of propulsion engines and emergency power to critical flight control systems. An additional apparatus disclosing an electrical power system for an aircraft was issued as U.S. Pat. No. 5,939,800 Artinian et al. in 1999. The '800 patent includes an air conditioning system generator and a main engine generator supplying backup a.c. power to the primary a.c. power bus supplied by the air conditioning system generator.

U.S. Pat. No. 6,127,758, issued to Murray et al. in 2000, discloses a ram air turbine that includes a reaction turbine and a variable-speed electrical generator that is driven by shaft power of the reaction turbine. A scoop directs a flow of ram air to an inlet of the reaction turbine and creates a pressure head for the turbine.

U.S. Pat. No. 6,283,410, issued to Thompson in 2001, discloses a secondary power generation system for a pressurized aircraft, which uses pressurized cabin air to support combustion in a turbo machine driving the secondary system.

U.S. Pat. No. 5,005,361, issued to Phillips in 1991, discloses a turbine power plant that produces power from a high temperature plasma and high voltage electricity. A plurality of ion repulsion discharge chambers are situated along the perimeter of the turbine to accelerate the ions, and a condenser and pump are used to return the condensed gases back to a plasma generator.

U.S. Pat. No. 4,095,118, issued to Rathbun in 1978, relates to a solar energy conversion system which includes a centrally positioned tower supporting a solar receiver and an array of pivotally mounted reflectors disposed circumferentially therearound which reflect earth incident solar radiation onto the receiver, and which thermally excites and photo-ionizes a working fluid to form a plasma. The plasma is accelerated and further heated through a ceramic turbo-compressor into a magnetohydrodynamic generator to produce direct current.

U.S. Pat. No. 4,146,800, issued to Gregory et al. in 1979, presents an apparatus and method of generating electricity from wind energy, which uses the earth as one of the plates of a condenser while the other plate is a fence-like structure through which the wind can blow from any direction.

U.S. Pat. No. 3,554,669, issued to Reader in 1971, discloses a device for converting electrical energy into fluid energy and vice/versa. The basic device is a laminate structure comprised of two electrically conductive, channeled electrode members, an emitter, and a receiver, which are spaced a given distance from each other and joined between layers of electrically insulating material. The channels of the emitter and receiver are aligned so as to form a flow passage through the device. A direct current electrical power supply is provided between the emitter and receiver, causing fluid to be pulled from an inlet through the channels of the emitter and receiver and out an exit of the device.

U.S. Pat. No. 3,975,651, issued to Griffiths in 1976, relates to a method and apparatus for generating electrical energy either as a direct or alternating current output, wherein an electric current is passed axially through a continuous flow of electrically conductive fluid in a duct member. The fluid is moved at a high velocity so that the circumferential magnetic field due to the electric current travels with the fluid and induces radially directed electromotive forces and current flow in a further conductive device disposed externally about the duct member.

Numerous devices have disclosed improvements in the efficiency of jet engines. U.S. Pat. No. 4,500,052, issued to K. Kim in 1985, discloses a jet propulsion system utilizing a liquid fuel prevaporization and back burning induction jet thrust transition tailpipe, the tailpipe having a primary inlet adapted to a turbojet engine and having a diverging area terminating in a thrust nozzle.

U.S. Pat. No. 4,519,563, issued to R. Tamura in 1985, discloses a pollution reducing aircraft propulsion system wherein aircraft engine exhaust is mixed with air and fuel and recombusted. Air is drawn into the secondary combustion chamber from suction surfaces on wings, and exhaust of the secondary combustion chamber is blown over the wing and fuselage surfaces.

U.S. Pat. No. 4,892,269, issued to Greco et al. in 1990, discloses a pusher turboprop engine with an interior exhaust duct structure which directs the hot turbine gasses through and out the engine nacelle to an annular duct mounted on the rear spinner which surrounds the propeller hub. The rotating annular duct includes blade-shaped shields which protect the roots of the propeller blades from the hot exhaust gasses and also pulls warmed cooling air through the engine nacelle thereby providing a rearwardly directed jet thrust to augment the propeller thrust.

U.S. Pat. No. 5,106,035, issued to J. Langford III in 1992, discloses an aircraft propulsion system having an electrochemical fuel cell for receiving an oxidizer and providing propulsion power to an electric motor driving a propeller. An air liquefaction system is used for receiving ambient air and providing oxidizer to the fuel cell.

U.S. Pat. No. 3,303,650, issued to O. Yonts in 1967, describes an ion propulsion system for space vehicles wherein A.C. power is utilized for ion acceleration thereby reducing the size and weight of required power supply components. The '650 patent discloses a space charged neutralized beam for the ionic propulsion of a space vehicle having at least one pair of ion sources. Each of the sources includes a plurality of elongated cavities, a charge material disposed within the cavities, an A.C. heater mounted adjacent to the charge material in each cavity for heating and substantially completely ionizing the charge material, a source of A.C. power connected to each of the heaters, and an ion exit slit disposed in one wall of each of the cavities.

None of the above inventions and patents, taken either singly or in combination, is seen to describe the instant invention as claimed. Thus a jet aircraft electrical energy production system solving the aforementioned problems is desired.

### SUMMARY OF THE INVENTION

The jet aircraft electrical energy production system of the present invention produces electric energy and increases the efficiency of the combustion phase of a jet engine through both the thermal and mechanical excitation of fluid ions.

Furthermore the present invention facilitates the extraction of gaseous elements from the atmosphere for liquefaction and utilization as a fuel for the jet engine or rocket motor.

Applicable to ram jet and turbojet engines, the system produces electrical energy through the collection of electrons separated from molecules in a large volume of ambient air passing with high velocity through a series of tubular sections made up of repeating combinations of heating assemblies and variable positive voltage grids. The tube sections cause the molecules to undergo loss of electrons through mechanically induced atomic and molecular impacts and thermal excitation, the free electrons then being collected by the voltage grids and stored in an external battery, or routed to an amplifier/controller for further utilization.

In addition to creating electric energy, the resultant positively charged and highly reactive molecules are combined with jet fuel in the combustor, resulting in greater thrust than would normally be generated, as the hot flow of the resultant combustion exits the combustor. Discharge electrodes positioned rearward of the combustors release excess electrons into the exhaust, thereby neutralizing the charge on the exhaust gas while providing additional thrust.

Accordingly, it is a principal object of the invention to provide a jet aircraft electrical energy production system that produces electrical energy by extracting electrons from high velocity ionized air.

It is a further object of the invention to provide a jet aircraft electrical energy production system that uses ionization of air molecules to enhance the thrust output of a jet engine.

Still another object of the invention is to provide a system that extracts oxygen or other gaseous elements from the high velocity ambient air taken in by a jet engine.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a jet aircraft electrical energy production system according to the present invention incorporated in a jet engine mounted beneath the wing of a jet aircraft.

FIG. 2A is a diagrammatic side perspective view of a jet aircraft electrical energy production system according to the present invention incorporated into a single spool turbojet engine.

FIG. 2B is a diagrammatic side perspective view of a jet aircraft electrical energy production system according to the present invention incorporated into a gas turbine engine having a centrigual compressor, fized difuser, and integral manifold.

FIG. 3 is a diagrammatic side perspective view of a jet aircraft electrical energy production system according to the present invention incorporated into a ram jet engine.

FIG. 4 is a fragmented perspective view of the ridged plates in a jet aircraft electrical energy production system according to the present invention.

FIG. 5 is a detailed cutaway perspective view of several. ridged plates in a jet aircraft electrical energy production system according to the present invention.

FIG. 6 is a side perspective view of the variable voltage grid section in a jet aircraft electrical energy production system according to the present invention.

FIG. 7 is a cross-sectional view of the union of two ridged plate tube sections onto a variable positive voltage grid section in a jet aircraft electrical energy production system according to the present invention.

FIG. 8 is a block diagram of the control logic for the energy production system, according to the present invention.

FIG. 9 is a diagrammatic side perspective view of another embodiment of the present invention, which includes a ram air induced, ionization section to extract fuel components from the ambient air, liquify the extracted components and reintroduce these components in proportionate amounts into the combustor section of a rocket exhaust nozzle.

Similar reference characters denote corresponding features consistently throughout the attached drawings.

### DETAILED DESCRIPTION OF THE PREFERRED EMBODIMENTS

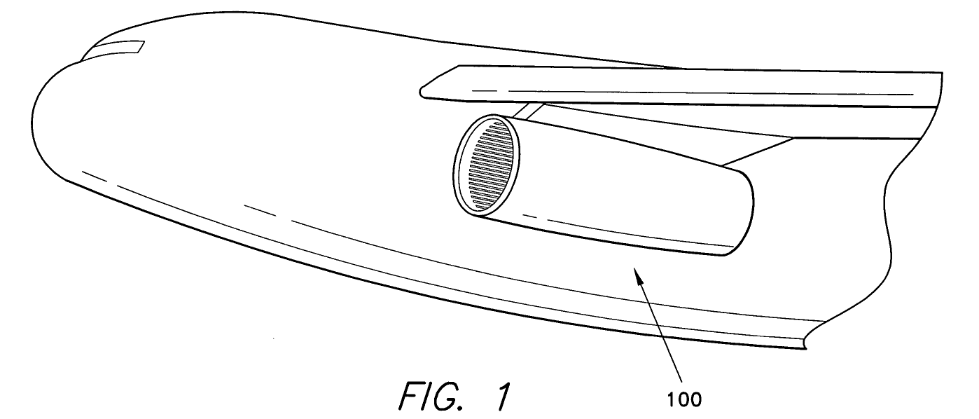

The present invention is directed to an electrical energy production system for jet aircraft, designated generally as 100 in the drawings. Integrated into the axial flow of a jet aircraft engine, as shown in FIG. 1, the present invention has the added functionality of increasing the output thrust of a jet engine using the ionization of air molecules to provide a more reactive component of combustion thereby increasing the output thrust output of a ram jet or turbojet engine.

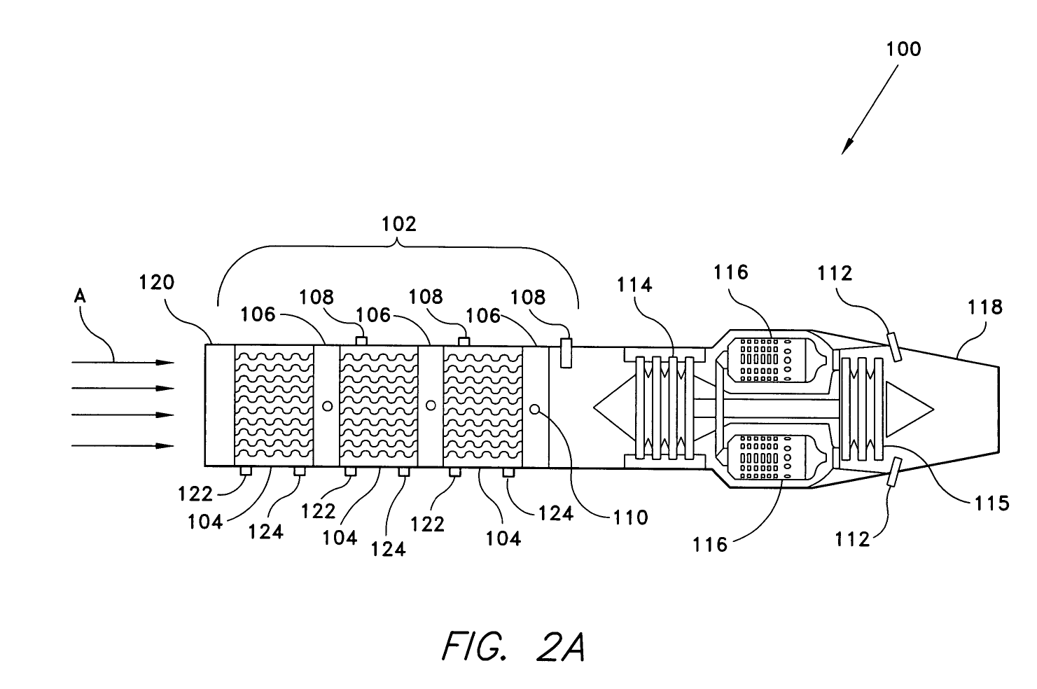

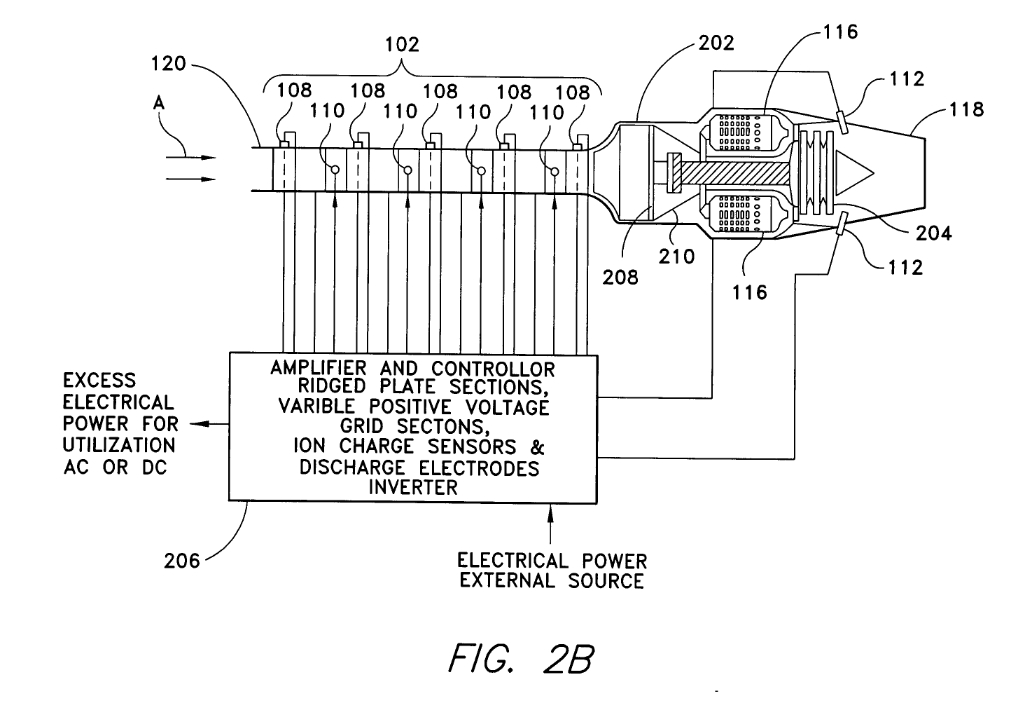

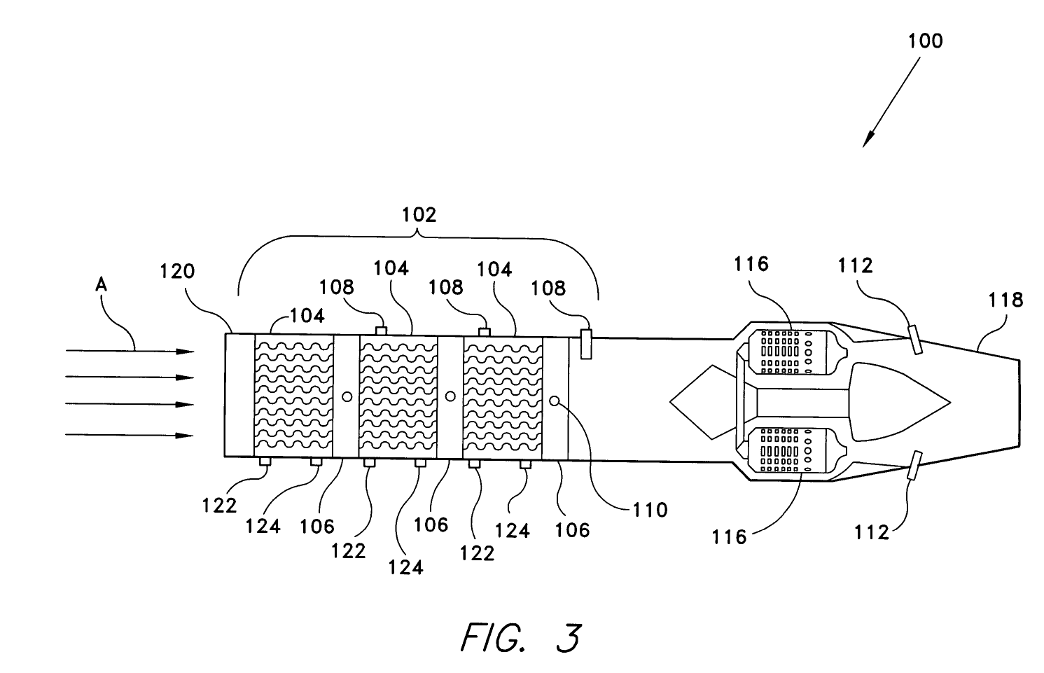

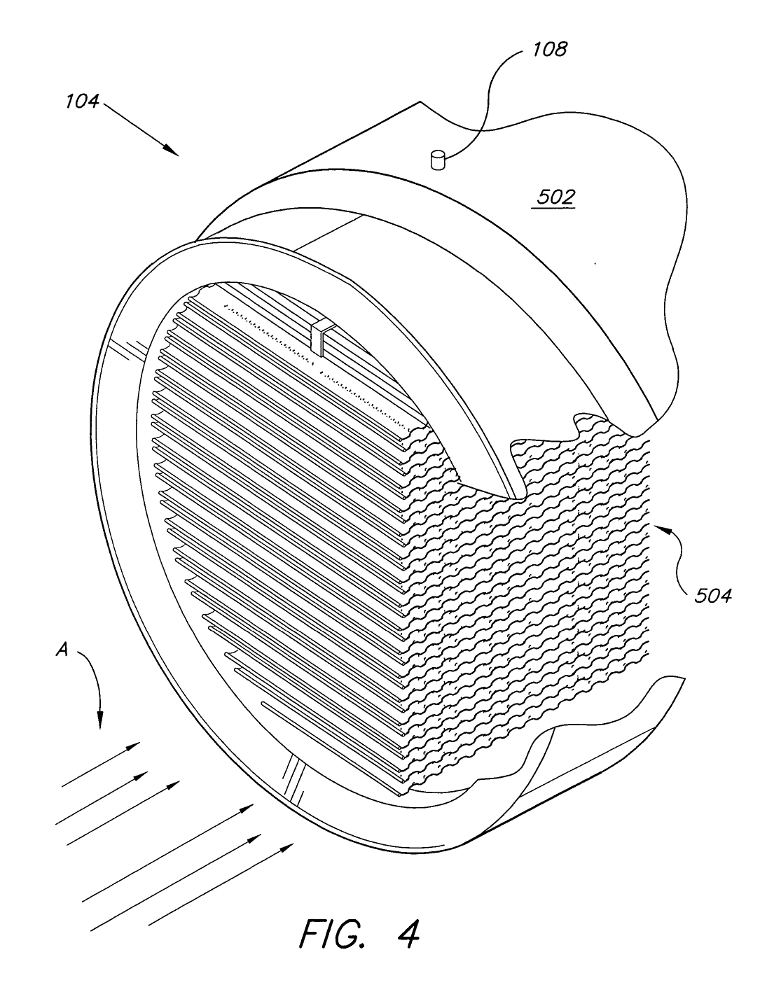

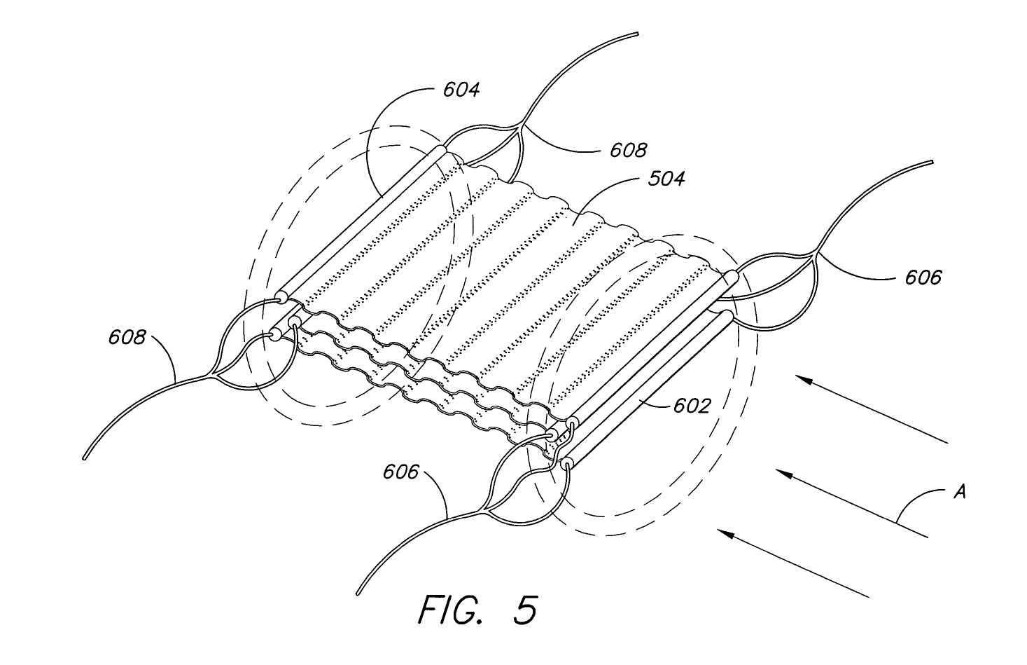

The system 100 is preferentially embodied as modifications to jet engines, as shown in FIGS. 2A, 2B, and 3. The gas ionization and energy production section 102 is similar to the apparatus disclosed in the inventor's prior U.S. Pat. No. 6,486,483, hereby incorporated by reference in its entirety. The gas ionization and electric energy production section 102 generates electricity by forcing large volumes of ambient air A through a series of separate tubular sections butted together, and may be joined by a number of ways commonly known that will ensure integrity of the structure under stresses induced by high pressures that may build within section 102. Each tubular section includes a heating assembly section 104 and a positive voltage grid section 106. The heating assembly section 104 consists of a plurality of metal alloy ridged plates 504 and will be discussed in more detail in the discussion of FIGS. 4 and 5.

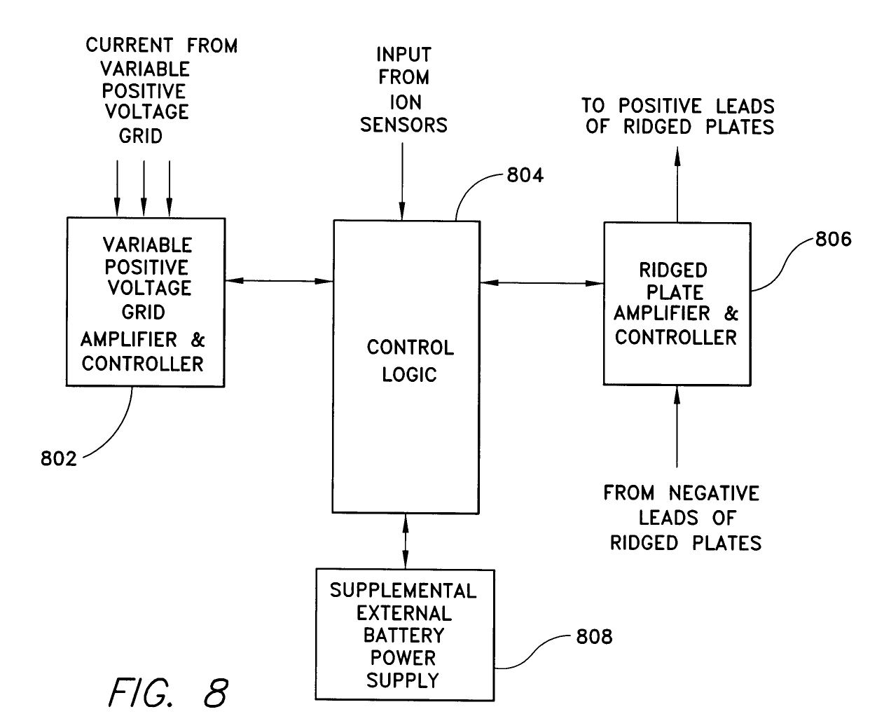

The heat radiating ridged plates 504 progressively increase the temperature of the air in each succeeding heating assembly 104 thereby continuing the ionization process. As the air molecules start to loose electrons and become more positive, ion charge sensors 108 monitoring the ionization of the air as it passes through each stage of ionic excitation. Based upon input from the ion sensors 108, the control logic shown in FIG. 2B and FIG. 8 automatically increases the positive voltage potential on the next succeeding variable positive voltage grid 106 in the line of medium flow to continue the electron disassociation process, thereby maintaining a constant flow of free electrons originating from the variable positive voltage grids 106, to the electrical studs 110 protruding from each variable positive voltage grid section 106. Variable positive voltage generation circuits are known to those skilled in the art and typically generate a positive voltage that increases or decreases in accordance with an increase or decrease in the entered high-frequency power.

As shown in FIG. 2B, immediately behind the gas ionization and energy production section 102 is the centrifugal compressor 202, fixed diffuser 208, and integral manifold 210. As is commonly known to those in the field of jet engines, the centrifugal compressor 202, fixed diffuser 208, and integral manifold 210, are affixed to combustors 116 and the exhaust gas turbine 204.

Although electrons extracted from the airflow through the operation of the gas ionization and energy production section 102 may be used to generate electrical energy, some electrons are routed to the discharge electrodes 112 mounted rearward of the exhaust turbines 115, 204 shown FIG. 2A and 2B. Discharge electrodes 112 vary in design, including but not limited to concentric rings of “V” shaped cross section, and are commonly known as flame holders to those knowledgeable in the field. By reintroducing electrons into the exhaust nozzle 118, the discharge electrodes 112 enhance ignition of the reactants, in addition to neutralizing the static charge build-up at the exhaust nozzle 118. The discharge electrodes 112 are constructed of a conducting material sufficient to withstand the heat generated by the combustor 116, as well as the force of the exhaust on the exhaust nozzle 118.

As shown in FIG. 3, aircraft powered by ram jet engines function by flying through air at high speeds, compressing the air into the engine purely by virtue of the high velocity of the aircraft. The highly agitated air passes through the gas ionization and electric energy production section 102, fuel saturated, and combusted without the need of a turbine and compressor. The combustion chamber 116, electron discharge electrodes 112 and exhaust nozzle 118 are similar to those of the gas turbine and centrifugal compressor engines of FIGS. 2A and 2B.

As shown in FIGS. 4 and 5, each of the ridged plate sections 104 includes a plurality of metal alloy ridged plates 504 held in spaced-apart, parallel, relationship to each other and embedded in an electrical insulating casing material 502, such as a ceramic composition. The ridged plates 504 are preferably made of an electrically conductive material having excellent heat radiation properties, but able to withstand subsonic and supersonic shock wave pressures, produced by high velocity air flows A. The casing 502 will preferably be constructed of electrical insulating material which is also capable of withstanding subsonic and supersonic shock wave pressures produced by high velocity airf lows. The leading and trailing edges 602, 604 of each ridged plate 504 have an elongated rod or cylindrical end portion disposed along the free edge thereof, substantially as shown, so as to maximize shock wave control.

Electric current impressed upon connectors 122, 124 mounted to the heating assembly section 104 heats the ridged plates 504, the electricity transmitted to the leading 602 and trailing 604 edges by conducting wires 606 and 608 respectively. Furthermore, an even flow of current from the leading edge 602 towards the trailing edge 604 is guaranteed by a dual electrical connection 606 on the leading edges 602 and a similar dual connection 608 on the trailing edge 604. The same construct will be on each plate on both the leading 602 and the trailing 604 edges, extending from both sides of the leading and trailing edges to provide a more thorough heat distribution on each plate. In the preferred embodiment, leading edge 602 provides a positive electrical lead and trailing edge 604 provides a negative electrical lead for heating the plates 504.

The ridged plates 504 are preferably constructed to define a wave pattern in cross-section (e.g., a sine wave), which, along with the characteristics of the metal alloy that give the plates excellent conductivity and heat radiating properties, makes them strong enough to withstand subsonic and supersonic shockwave pressures produced by high velocity air flows. The spacing between each plate 504 is sufficiently narrow to attain atomic and molecular disassociation, while at the same time, sufficiently spaced apart to allow supersonic airflow.

The leading and trailing end portions 602, 604 of each plate 504 are preferably staggered fore and aft with respect to each other and spaced-apart, substantially as shown, improving shock wave control. The ridged plates 504 are positioned substantially parallel to one another and may vary in number. The number of ridged plates 504 contained within a particular energy production section 102 may also vary, dependent on the size of the entire system 100 and the velocity of airflow A, and may increase downstream to compensate for less dense air being processed. The sizes of the respective component parts of the invention vary, depending on the application. Heated ridged plates 504 are only one of a number of possible designs that may be used to excite atoms and molecules to dissociation as they travel within high velocity airflows.

Furthermore, the invention is not limited regarding the number of repeating combinations of variable positive voltage grids 106 and ridged plate sections 104. The ridged plates 504 may have conventional structural support elements, to help prevent implosion from high velocity airflows A. It should be understood that the invention embraces any structural support elements for the individual plates 504, whether located between a pair of plates 504, adjacent the plates 504, or otherwise located with respect thereto for improving resistance to material or structural degradation secondary to the effects of airflow A.

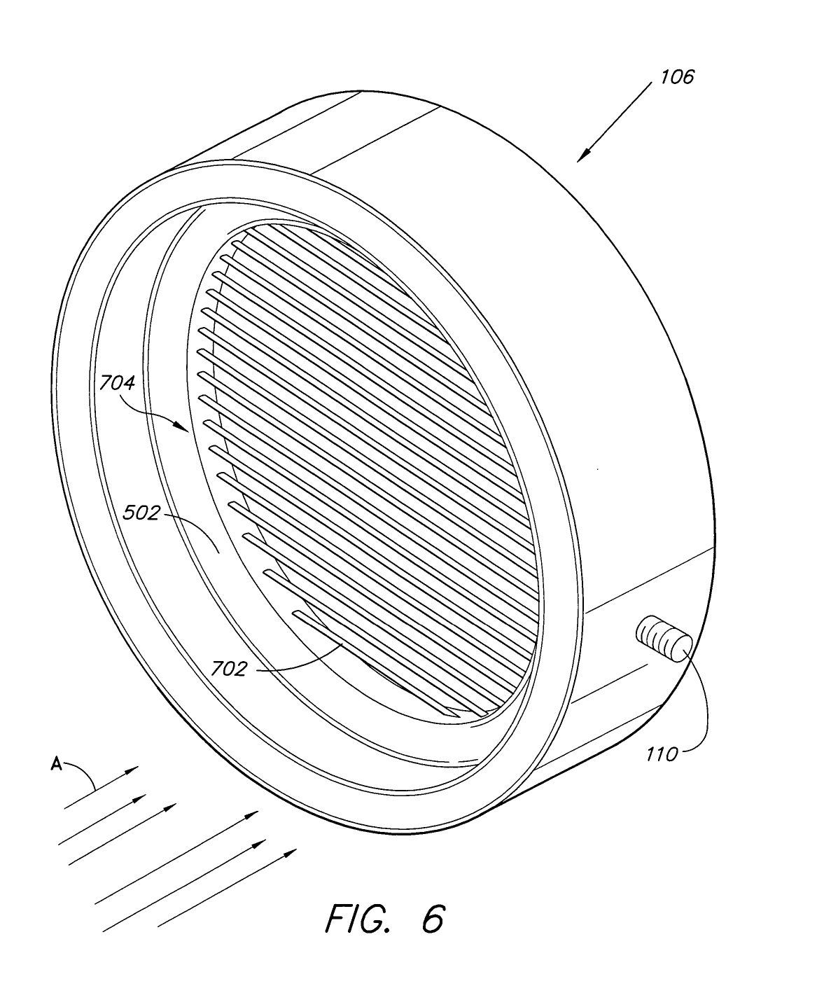

FIG. 6 illustrates the variable positive voltage grid section 106 in greater detail. Made up of a generally tubular casing 502, the variable positive voltage grid section 106 preferably includes an alloy grid 704 having high electrical conductivity, and having aerodynamic parallel vanes 702, both sides of each vane 702 being fixed in casing 502 and designed to withstand extremely high velocity airflows. In the present embodiment, grid 704 is electrically connected to a single stud 110 that protrudes through casing 502.

Casing 502 may be constructed of electrically insulating material capable of withstanding high temperatures, pressures, and vibrations. The grid 704, and the vanes 702 attached thereto, are of a construction sufficiently strong to withstand vibration, high temperatures and pressures caused by supersonic and hypersonic airflows. The protruding stud 110, of which there is one for each variable positive voltage section 106, is connected to a variable positive voltage potential, controlled by the circuit components diagrammatically indicated in the block diagram of FIG. 8. This variable positive voltage potential will extract the free electrons and will help accelerate the ions as they move through the electric energy production section 102. The positive voltage potential of each grid section 106 progressively increases to continue the process of ionization of the atoms and molecules, and helps to accelerate the ions.

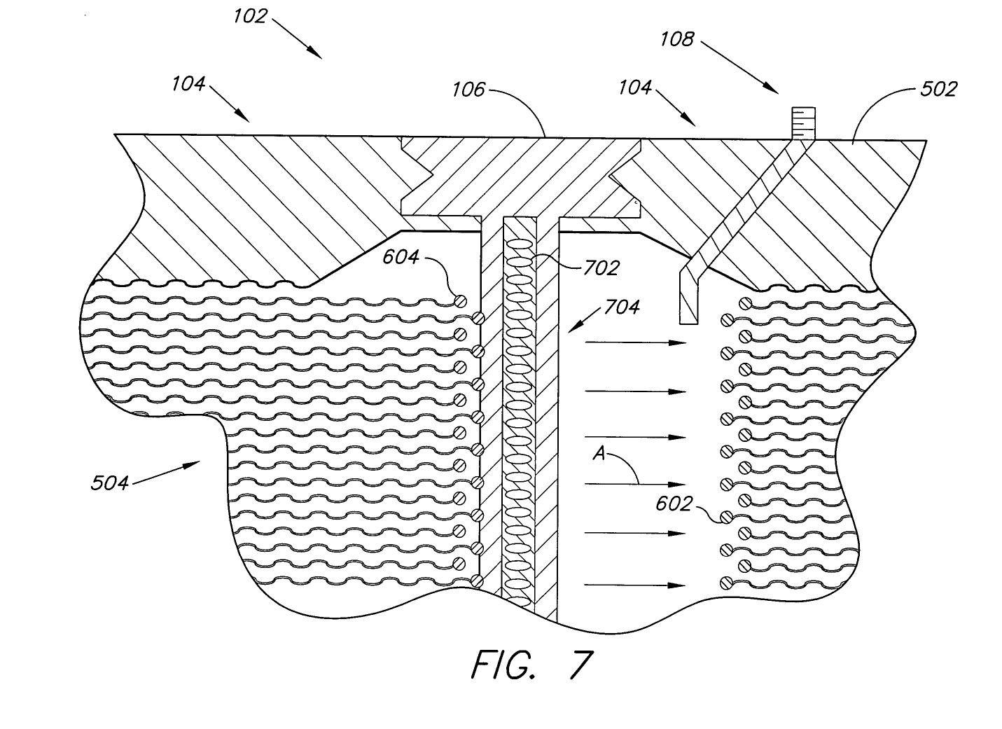

FIG. 7 illustrates two heating assemblies 104 separated by a variable voltage positive grid section 106. FIG. 7 further illustrates an ion charge sensor 108 mounted through casing 502, the sensor 108 detecting the charge of the ions as they flow through the electrical energy production section 102. The ion charge sensors 108 are connected to the control logic shown in FIG. 8 and operate to keep the variable positive voltage grids 702 at a greater positive potential as compared to the charge on the ions in the airflow to help accelerate the flow and dissociation process. The ion charge sensors 108 are preferably configured to be aerodynamic and able to withstand supersonic airflows. Conventionally, ion detectors include a sensing electrode, an evaluating circuit, and an indicator means. In the preferred embodiment of the invention, the ion charge sensor 108 controls the variable positive grid 106 to its immediate rear.

In the preferred embodiment, the last section before the combustor 116 is a variable positive voltage grid 106 to continue the extraction of free electrons before entering the combustor section 116.

Again referring to FIG. 7, the cylindrical trailing edge 604 of each ridged plate section 104 should be in close proximity to the variable positive voltage grid 106 to immediately attract and extract the free electrons. The variable positive voltage potential, as well as the radiating heat of the ridged plates 504 may progressively increase from the front to the rear sections to continue the ionization and dissociation process. In one embodiment of the invention, the vanes 702 of the variable positive grid 704 may be parallel to the ridged plates 504 to maximize extraction of free electrons. Ion sensors 108 generally located foreword of the ridged plate tube sections 104 detect the charge of the ions at each stage and may automatically increase the potential of the variable positive voltage grids 704 to a higher positive potential as compared to the ions to help accelerate the velocity, increase dissociation, and have a greater potential for extracting electrons.

The electrical energy production section 102 preferably starts with a ridged plate tube section 104 at its respective front to start the electron dissociation process, and ends with a variable positive voltage grid section 106 at its respective rear so as to continue the extraction of free electrons as much as possible. The process of extreme high velocity air flow through a repeated combination of ridged plate tube sections 104 and variable positive voltage grid sections 106 should create atomic and molecular disassociation and free electrons from their normal orbits; these free electrons will be attracted to the variable positive voltage grid 106 and extracted for utilization.

As shown in FIG. 8 and touched upon previously, The operation of the system 100 is regulated by control logic which monitors the charge on the medium as it flows through the tubular sections and regulates the voltage to the positive voltage grid sections 106. The control logic is also responsible for controlling the current to the heating assembly sections 104 thereby guaranteeing increased ionization as the medium progresses through the energy production section 102, as well as controlling the neutralization of the charge on the exhaust by means of the discharge electrodes 112. Specifically, input from the ion sensors 108 is monitored by the control logic 804. The control logic 804, in turn, electronically communicates with the ridged plate amplifier and controller logic 806 that regulates heating assemblies 104. Under control of control logic 804 and the variable positive voltage grid amplifier and controller 802, the voltage applied to the variable positive voltage grid 106 is adjusted and the current drawn off from the grid 106 is regulated. A source of supplemental power 808 provides backup power and serves as a means for bootstrapping the device until electric energy is produced in sufficient quantity to operate the control logic.

In addition to generating electrical energy, the system 100 improves thrust efficiency by fuel ionization. The system 100 causes the atoms or molecules of high velocity air flowing in through the intake 120 to undergo ionization through the loss of electrons by means of thermally and mechanically induced atomic and molecular impacts, thermal excitation, and the presence of positively charged grids 106. Atoms so ionized more readily oxidize fuel and may be further excited by means of a turbine 114, causing the reactants of the combustion process to expand more readily and at greater temperature, thereby increasing thrust output and efficiency as the exhaust exits the nozzle 118.

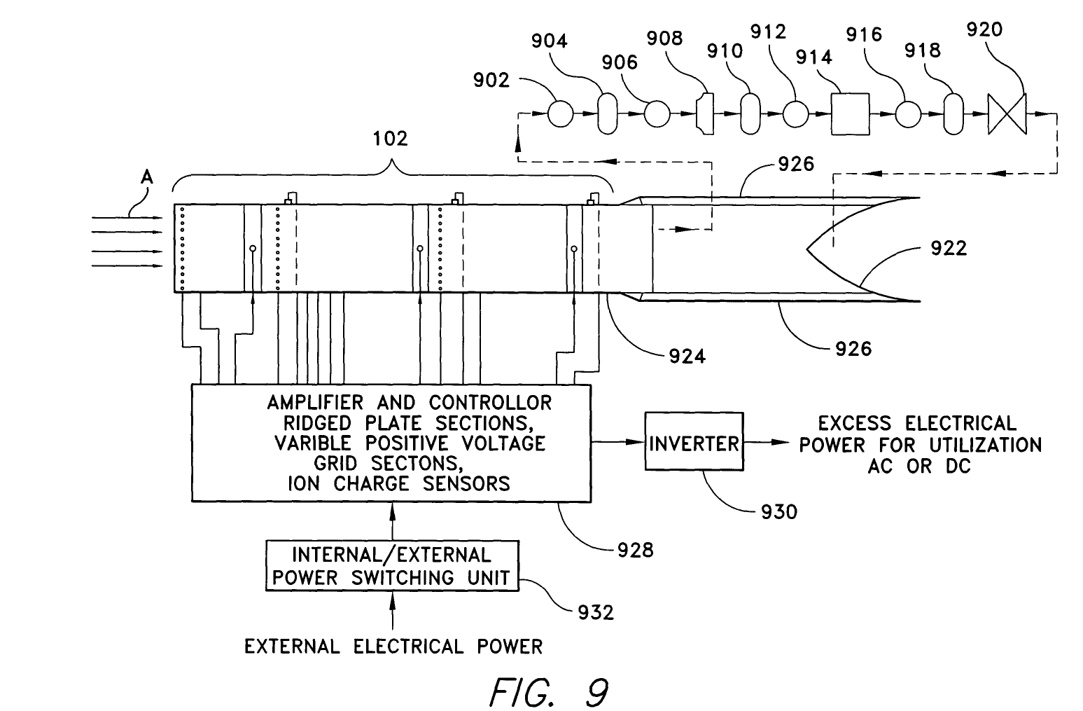

A further variation of the system 100 is shown in FIG. 9, and operates to extract oxygen atoms from the atmosphere and convert them to liquid oxygen for use as fuel for the engine. Although FIG. 9 is representative of components required to extract liquid oxygen from the atmosphere, the same construct may be used to extract hydrogen or any other gaseous element contained within the ambient air A taken in by the engine. Components of the present invention may be mounted within the engine housing or may be mounted in the vehicle to which the engine is mounted.

The embodiment of the invention shown in FIG. 9 utilizes at least one ion vacuum pump 902 in combination with a high velocity ion mobility spectrometer 904, to draw out ions from a plasma staging area 924. At least one compressor 908 may be incorporated to maintain the required pressure necessary to convert oxygen atoms flowing out of the ion mobility spectrometer 904 to liquid oxygen in conjunction with countercurrent heat exchanger 910. The low temperature liquids necessary for proper operation of the heat exchanger 910 may be carried in reserve tanks on board the aircraft until sufficient quantities of liquid extracted as a result of the aforementioned process is produced. Pump 912 may preferably pump liquid oxygen into a fuel storage tank 914 before being pumped out for controlled utilization though combustion nozzle 920 and rocket exhaust nozzle 922, by means by liquid oxygen pump 916 and liquid oxygen regulator/pressure control unit 918.

Control module 928 is responsible for operating the gas ionization and electric energy production section 102 as well as controlling pressure in the plasma staging chamber 924 by means of computer controlled relief valves and excess pressure plasma exhaust ducts 926. The ducts 926 are electrically insulated as well as all areas in direct or indirect contact with the plasma. The DC generated by the device may be used directly by devices requiring a DC power source, or alternatively, may converted to AC by inverter 930.

A power-switching unit 932 is responsible for supplying electrical power for all components. Power is derived either from the gas ionization and electrical power production section 102 or from an external electric power source.

The entire engine is electrically insulated to minimize static charge build-up. The ducts 926 are routed to expel the plasma rearward of the engine, and various means including aforementioned discharge electrodes may be used to electrically neutralize the plasma.

A further variation of the present invention embodies present day conventional axial flow jet engines, the stator vanes in conventional axial flow engines may be electrically isolated and insulated from the rest of the engine, and a positive voltage applied, to attract and extract any free electrons flowing there through. This modification on conventional axial flow jet engines would have the same results as aforementioned embodiments, to produce electrical power and simultaneously improving combustibility of gaseous elements flowing there through to produce greater thrust.

As with all these different embodiments, electrically isolating the entire engine from the rest of the aircraft is paramount to prevent electrical discharge due to high static charge build up in and around the engine.

It is to be understood that the present invention is not limited to the embodiments described above, but encompasses any and all embodiments within the scope of the following claims.

1. A jet aircraft electrical energy production system for an axial flow jet engine, the jet engine having a combustor and an exhaust nozzle aligned along a longitudinal axis, the combustor being mounted forward of the exhaust nozzle, the energy production system comprising:
an energy production section having an input end and an output end, the section having a series of abutting tubular sections adapted for mounting forward of the combustor, the tubular sections defining a central longitudinal airflow path through the energy production section; and
at least one discharge electrode adapted for mounting rearward of the combustor, the discharge electrode being electrically connected to the energy production section.

2. The aircraft electrical energy production system of claim 1, wherein each of said tubular sections further comprises:
a heating assembly including a plurality of heating plates for ionizing air flowing through the energy production, said plurality of heating plates being disposed in spaced-apart relationship to allow the flow of the air through the heating assembly;
a variable positive voltage grid for collecting charged particles downstream of the heating assembly; and
at least one sensor in the airflow path for detecting the charge of the charged particles.

3. The aircraft electrical energy production system of claim 2, further comprising a control means for responsively controlling each of said heating plates and each said grid.

4. The electrical energy production system of claim 3 wherein said control means is programmed for heating each said heating assembly to a progressively higher temperature as distance from said input increases, such that air traveling through said series of sections comes in contact with successively hotter heating assemblies.

5. The electrical energy production system of claim 2 wherein each said grid has an increased electrical charge as distance from said input increases, such that air traveling through said series of sections comes in contact with successively higher charged grids.

6. An engine assembly for propulsion of an aircraft, comprising:
an electric energy and plasma production section having an input end and an output end, and having a series of abutting tubular sections mounted rearward of said input end, the tubular sections defining a central longitudinal airflow path through the energy production section;
means for inducing flow of air into said input;
a plasma staging section mounted rearward of said output end;
means for separating said plasma into component elements;
means for liquefying the individual component elements;
at least one fuel nozzle for releasing the liquefied component elements;
means for pumping said component elements through said at least one nozzle; and
an exhaust nozzle aligned along a longitudinal axis with and disposed rearward of said at least one nozzle.

7. The aircraft propulsion system of claim 6, wherein said means for inducing the flow of air into said inlet includes a ram jet engine.

8. The aircraft propulsion system of claim 6, wherein each of said tubular sections further comprises:
a heating assembly including a plurality of heating plates for ionizing air flowing through the airflow path, the plurality of heating plates being disposed in spaced-apart relationship to allow the flow of air through the heating assembly;
a variable positive voltage grid for collecting charged particles downstream from the heating assembly; and
at least one sensor disposed in the energy production section for detecting the charge of the charged particles and for responsively controlling a potential of said grid.

9. The electrical energy production system of claim 6, wherein each said heating assembly includes a plurality of heating plates.

10. The aircraft propulsion system of claim 6, wherein said each said voltage grid is a positive voltage grid.

11. The aircraft propulsion system of claim 6, further comprising means for storing liquefied component elements.

12. A method of increasing thrust in a jet engine comprising the steps of:
ionizing air molecules passing through the intake of the jet engine in order to produce an ionized medium;
combusting said ionized medium with jet fuel in a combustor, thereby creating an ionized exhaust; and
neutralizing the charge on the ionized exhaust.
